(19) United States
(12) Patent Application Publication
(10) Pub. No.: US 2026/0196798 A1
(43) Pub. Date: Jul. 9, 2026

(54) OPTICAL ARRANGEMENT

(71) Applicant: TRUMPF LASERSYSTEMS FOR SEMICONDUCTOR MANUFACTURING SE, Ditzingen (DE)

(72) Inventors: Dirk SUTTER, Rottweil (DE); Torsten MANS, Aachen (DE); Claus SCHNITZLER, Aachen (DE); Arvid HAGE, Herzogenrath (DE)

(21) Appl. No.: 19/551,630

(22) Filed: Feb. 27, 2026

Related U.S. Application Data
(63) Continuation of application No. PCT/EP2024/074727, filed on Sep. 4, 2024.

(30) Foreign Application Priority Data
Sep. 8, 2023 (DE) 10 2023 124 255.5

(51) Int. Cl. H01S 3/094; H01S 3/042; H01S 3/08; H01S 3/16

(52) U.S. Cl. CPC H01S 3/094; H01S 3/042; H01S 3/08054; H01S 3/163

(57) ABSTRACT

An optical arrangement includes a laser-active solid body configured to amplify and/or generate a laser beam. The laser-active solid body is in a form of a slab. The optical arrangement further includes a pump radiation source configured to generate a pump beam that propagates in a propagation direction and passes through the laser-active solid body for optical pumping the laser-active solid body, and a reflector arranged downstream of the laser-active solid body in the propagation direction of the pump beam. The reflector is configured to reflect the pump beam transmitted through the laser-active solid body back onto the laser-active solid body. The pump beam reflected by the reflector passes through the laser-active solid body for optical pumping the laser-active solid body.

### CROSS REFERENCE TO RELATED APPLICATIONS

This application is a continuation of International Application No. PCT/EP2024/074727 (WO 2025/051803 A1), filed on September 4, 2024, and claims benefit to German Patent Application No. DE 10 2023 124 255.5, filed on September 8, 2023. The aforementioned applications are hereby incorporated by reference herein.

### FIELD

Embodiments of the present invention relate to an optical arrangement.

### BACKGROUND

Optical arrangements are frequently used for the optical pumping of slab lasers. Slab lasers typically have a laser-active solid body in the form of a slab, in particular in the form of a slab-shaped laser-active crystal.

“In the form of a slab” can be understood to mean that the laser-active solid body is formed in a plate-shaped shape. In other words, the laser-active solid body can be cuboid-shaped, wherein the height of the laser-active solid body is less than its width and length. Such a shape allows for better cooling of the laser-active solid body, in particular improving the dissipation of heat generated by amplifying and/or generating a laser beam.

For the purpose of optical pumping, a pump beam is often coupled into the laser-active solid body at one end face of the laser-active solid body by means of the optical arrangement. After coupling in, the pump beam passes through the laser-active solid body and is coupled out of the laser-active solid body at an end face opposite the end face. To amplify an existing laser beam, it can be coupled into the laser-active solid body using the optical arrangement. After coupling in, the laser beam passes through the laser-active solid body and is amplified in an overlap region of the laser beam with the pump beam within the laser-active solid body.

EP 1 181 754 A1 discloses an optical amplifier arrangement with a shaped amplification medium in the form of a slab and two highly-reflective mirrors, between which the amplification medium is arranged.

### SUMMARY

Embodiments of the present invention provide an optical arrangement. The optical arrangement includes a laser-active solid body configured to amplify and/or generate a laser beam. The laser-active solid body is in a form of a slab. The optical arrangement further includes a pump radiation source configured to generate a pump beam that propagates in a propagation direction and passes through the laser-active solid body for optical pumping the laser-active solid body, and a reflector arranged downstream of the laser-active solid body in the propagation direction of the pump beam. The reflector is configured to reflect the pump beam transmitted through the laser-active solid body back onto the laser-active solid body. The pump beam reflected by the reflector passes through the laser-active solid body for optical pumping the laser-active solid body.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic representation of an exemplary optical arrangement according to embodiments of the invention;

FIG. 2 shows a schematic representation of a laser-active solid body of the optical arrangement of FIG. 1 according to some embodiments;

FIG. 3 shows a detailed view of a region III of FIG. 1 according to some embodiments; and

FIG. 4 shows a schematic representation of a further exemplary optical arrangement according to embodiments of the invention.

### DETAILED DESCRIPTION

Embodiments of the invention provide an optical arrangement which enables the amplification and/or generation of a laser beam with high efficiency.

An optical arrangement according to embodiments of the invention comprises a laser-active solid body, a pump radiation source and a reflector. The laser-active solid body is designed to amplify and/or generate a laser beam. The laser-active solid body is in the form of a slab. The pump radiation source is designed to generate a pump beam which propagates in a propagation direction and passes through the laser-active solid body for the purpose of optical pumping. The reflector is arranged downstream of the laser-active solid body in the propagation direction of the pump beam. The reflector is designed to reflect the pump beam transmitted through the laser-active solid body back onto the laser-active solid body. For the purpose of optical pumping, the pump beam reflected by the reflector passes through the laser-active solid body.

Advantageously, the optical arrangement enables an amplification and/or generation of the laser beam with high efficiency by reflecting the unabsorbed portion of the pump beam transmitted through the laser-active solid body back onto the laser-active solid body, thus optically pumping the laser-active solid body. This allows the use of pump radiation that is not absorbed during the first transmission of the pump beam through the laser-active solid body. Advantageously, the optical arrangement allows for a uniform distribution of the pump beam's power over the laser-active solid body, resulting in uniform heating of the laser-active solid body and thus less impact on the beam quality of the laser beam as it passes through the laser-active solid body.

Optical pumping can be understood as the effect of a population inversion caused by optical excitation, in particular due to an electron-photon interaction. A population inversion can exist when the energy levels of a particle or molecule are not occupied by electrons in the way that would be expected at a given temperature without optical excitation. In other words, optical pumping can be a process in which electrons in an atom or molecule are raised from a lower energy level to a higher energy level by means of the pump beam.

When the pump beam passes through the laser-active solid body, the pump beam can optically pump the laser-active solid body. Optical pumping involves partial absorption of the pump beam by the laser-active solid body, causing a population inversion in the laser-active solid body. Optical pumping reduces the power of the pump beam. The transmitted pump beam can be a remaining residue of the pump beam generated by the pump radiation source. The transmitted pump beam can be described as a pump beam that is not absorbed by the laser-active solid body. The transmitted pump beam can be a portion of the pump beam generated by the pump radiation source that has non-optically pumped the laser-active solid body after passing through it.

The pump radiation source can be a diode laser and, in particular, may have a laser diode.

A wavelength of the pump beam and a wavelength of the laser beam can differ from each other. The wavelength of the pump beam can be coordinated to the laser-active solid body, in particular to the material of the laser-active solid body, in such a way that the laser-active solid body is optically pumped with the pump beam. The wavelength of the laser beam can be coordinated to the laser-active solid body in such a way that the laser beam can be amplified by stimulated emission using the laser-active solid body.

The wavelength of the pump beam can be 850 nm to 990 nm, in particular 880 nm to 890 nm, preferably 885 nm. The wavelength of the laser beam can be 1000 to 1180 nm, in particular 1060 nm to 1065 nm. The abbreviation nm stands for nanometer.

The amplification and/or generation of the laser beam using the laser-active solid body can be achieved by means of stimulated emission. The laser beam and the pump beam can overlap, in particular superimpose, one another within the laser-active solid body. In particular, the laser beam and the pump beam can overlap temporally and spatially within the laser-active solid body. The laser beam and the pump beam can overlap within the laser-active solid body in such a way that they propagate within the laser-active solid body, amplifying the laser beam. The propagation direction of the laser beam and the propagation direction of the pump beam can differ from each other.

The reflector can be a retroreflector or a mirror, in particular a Bragg mirror. The reflector can have a highly reflective, in particular dielectric, coating for the pump beam. The reflector can be arranged on an end surface or an end face of the laser-active solid body.

The reflector can be designed to reflect the transmitted pump beam in such a way that the pump beam overlaps, in particular superimposes, at least partially with itself within the laser-active solid body before reflection by means of the reflector and after reflection by means of the reflector.

The laser-active solid body can have, in particular be, a crystal, in particular a crystal structure. The laser-active solid body can also be called a laser crystal.

In a further development of the optical arrangement, the reflector is configured to reflect back the pump beam transmitted through the laser-active solid body with a spatial offset and/or angular offset. The spatial offset is configured such that the pump beam reflected by the reflector hits the pump radiation source with less than 5%, in particular 3% or 2%, of its power. Advantageously, this avoids damage to the pump radiation source from the reflected pump beam and excessive heating of the pump radiation source. In particular, 5%, in particular 3% or 2%, of the power of the reflected pump beam can strike the pump radiation source without affecting and/or damaging the pump radiation source.

In a further development of the optical arrangement, the reflector is configured such that a value of the angle of incidence of the pump beam transmitted through the laser-active solid body is not equal to 0° relative to the reflector. Additionally or alternatively, the reflector is configured such that a value of the emergent angle of the pump beam reflected by the reflector is not equal to 0° relative to the reflector. The value of the angle of incidence and the value of the emergent angle can be the same.

In a further development, the optical arrangement includes a polarizer. The polarizer is arranged between the pump radiation source and the laser-active solid body. The polarizer is configured to filter the pump beam according to its polarization in such a way that the pump beam has a linear polarization after the polarizer. The optical arrangement has a λ/4 plate. The λ/4 plate is arranged between the polarizer and the reflector. The λ/4 plate is configured to convert the linear polarization of the pump beam into a circular polarization of the pump beam and the circular polarization of the pump beam into a linear polarization of the pump beam. The polarizer can be designed to deflect the pump beam depending on its polarization.

The λ/4 plate can be made of a birefringent material. The λ/4 plate can have a fast axis and a slow axis, wherein the λ/4 plate delays the phase of a beam component polarized parallel to the slow axis by a quarter of the wavelength of the pump beam compared to the phase of a beam component polarized parallel to the fast axis. λ denotes the wavelength of the pump beam.

The polarizer can be configured to filter the pump beam using dichroism, reflection, birefringence, scattering and/or diffraction depending on its polarization. The polarizer may be a film polarizer, a thin-film polarizer, a wire-grid polarizer, a crystal polarizer, a polarizing beam splitter, or a Brewster window, in particular.

The pump beam generated by the pump radiation source can be linearly polarized. The degree of polarization of the linearly polarized pump beam can be greater than 85%, in particular 90% or 95%.

The polarizer can be arranged in such a way that the pump beam passes through the laser-active solid body after passing through the polarizer.

In a further development of the optical arrangement, the λ/4 plate is arranged such that the pump beam passes through the λ/4 plate before being reflection by the reflector and the pump beam passes through the λ/4 plate after being reflection by the reflector. Advantageously, this can be achieved such that the pump beam, after reflection by the reflector and after passing through the λ/4 plate, is rotated by 90° in polarization relative to the polarization of the pump beam before passing through the λ/4 plate.

In a further development of the optical arrangement, the λ/4 plate is configured to change the polarization of the pump beam such that the linear polarization of the pump beam before passing through the λ/4 plate and the linear polarization of the pump beam reflected by the reflector after passing through the λ/4 plate are orthogonal to each other.

In a further development of the optical arrangement, the polarizer is configured to filter the pump beam reflected by the reflector depending on its polarization such that the pump beam reflected by the reflector hits the pump radiation source with less than 5%, in particular 3% or 2%, of its power. Advantageously, this avoids damage to the pump radiation source by the reflected pump beam. In particular, 5%, in particular 3% or 2%, of the power of the reflected pump beam can strike the pump radiation source without affecting and/or damaging the pump radiation source.

In a further development of the optical arrangement, the reflector is a wavelength-selective element that is configured to reflect a wavelength of the pump beam more strongly than a wavelength of the laser beam. The reflectivity of the reflector for the wavelength of the pump beam can be at least 95%, in particular 98%, 99%, 99.9% or 99.99%. The reflectivity of the reflector for the wavelength of the laser beam can be at most 5%, in particular 3%, 1%, 0.5%, 0.3% or 0.1%.

In a further development, the reflector is wavelength-selective such that it substantially reflects wavelengths within the absorption band of the laser-active solid body. In particular, reflected pump radiation directed backwards through the laser-active solid body can be largely absorbed or absorbed by the laser-active solid body after the double pass. Such wavelength selectivity can also prevent the emission of the pump radiation source from being undesirably shifted by feedback to a wavelength that is less well absorbed by the solid body.

In a further development of the optical arrangement, the laser-active solid body is formed from a material doped with ytterbium or neodymium ions. For example, the material is or comprises Yb:YAG, Nd:YAG, Yb:LuAG, Yb:CaF₂, Yb:CALGO, Yb:Lu₂O₃, Yb:Sc₂O_{3,} Yb:GGG, Yb:YLF, Yb:S-FAP, Nd:YVO₄, Nd:GdVO₄, Yb:KGW or Yb:KYW. Advantageously, these materials are particularly suitable for efficient amplification and/or generation of the laser beam and can exhibit low heat generation during amplification and/or generation.

In a further development, the optical arrangement has a cooling device for cooling the laser-active solid body. The cooling device can be described as a heat sink. The laser-active solid body can have contact with the cooling device. The cooling device can have a first cooling plate and a second cooling plate, wherein the first cooling plate is arranged on a first longitudinal side of the laser-active solid body and wherein the second cooling plate is arranged on a second longitudinal side opposite the first longitudinal side. The cooling device can be a water cooling device.

In a further development of the optical arrangement, the reflector has a curved surface. The reflector is configured such that a curvature of the curved surface is equal to a curvature of a phase front of the pump beam. Advantageously, this preserves a caustic shape of the pump beam after reflection by the reflector, resulting in improved overlap between the pump beam and the laser beam and thus more efficient amplification and/or generation of the laser beam. In particular, a caustic of the pump beam before reflection by the reflector and a caustic of the pump beam after reflection by the reflector can be formed identically.

In a further development, the optical arrangement is configured such that the laser beam propagates in a propagation direction and passes through the laser-active solid body. The propagation direction of the laser beam and the propagation direction of the pump beam have an angle of less than 45° to each other in the laser-active solid body. Advantageously, this results in a particularly compact optical arrangement.

Preferably, the device has an absorber for absorbing the pump radiation reflected at the reflector and directed backwards through the laser-active solid body. This absorber can be actively cooled. This pump radiation, which in particular was not absorbed by the laser-active medium, can be directed to this absorber by a polarizer and/or reflectors.

In a further development of the optical arrangement, the pump radiation source has a stabilization element for wavelength stabilization of the pump beam. This advantageously results in higher efficiency of the optical pumping. A spectrum of the pump beam can have a half-width of at most 5 nm, in particular 3 nm or 2nm. The stabilization element can have, in particular be a grating, in particular a volume Bragg grating. The stabilization element can be designed as an output coupler mirror of the pump radiation source. The stabilization element can be a bandpass filter, in particular a narrow bandpass filter, with a half-width of at most 5 nm, in particular 3 nm or 2 nm. The reflectivity of the stabilization element for the wavelength of the pump beam can be at least 5%, in particular 10% or 15%.

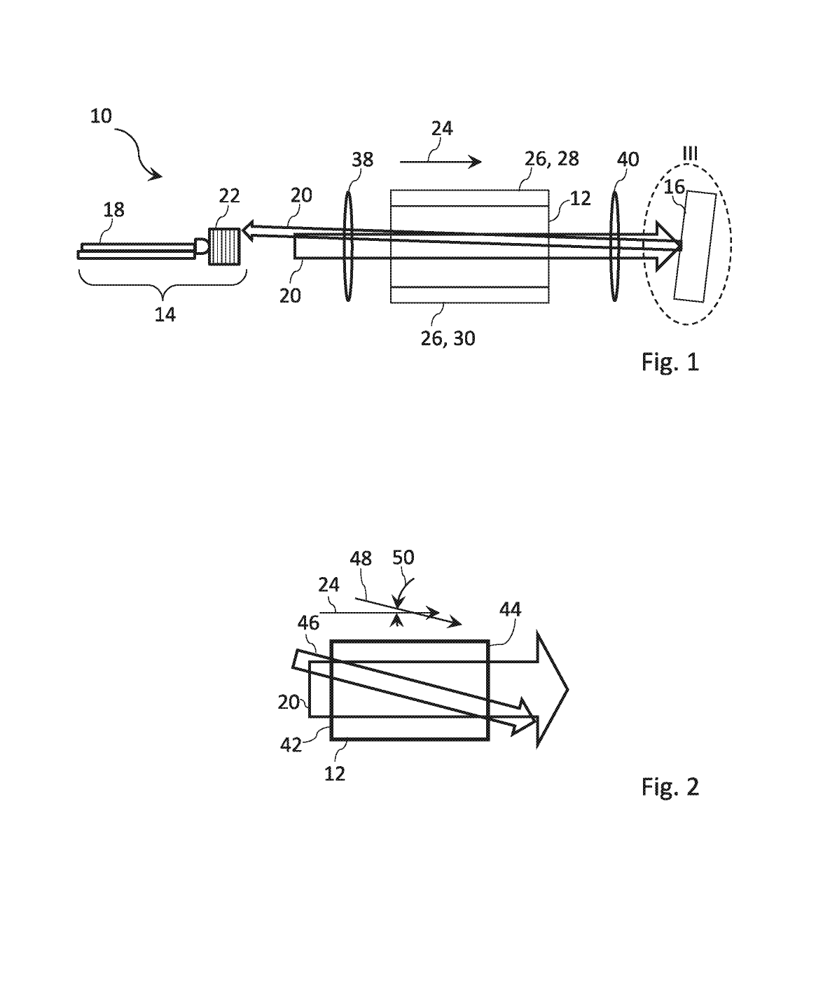

FIG. 1 schematically shows an optical arrangement 10. The optical arrangement 10 has a laser-active solid body 12, a pump radiation source 14, and a reflector 16.

The pump radiation source 14 is a diode laser and has a laser diode 18 to generate a pump beam 20. A wavelength of the pump beam 20 is 885 nm. The pump radiation source 14 has a stabilization element 22 for wavelength stabilization of the pump beam 20. The stabilization element 22 is a volume Bragg grating. The stabilization element 22 is an output coupler mirror of the pump radiation source 14. For example, the reflectivity of the stabilization element 22 for the wavelength of the pump beam 20 can be 5%. The stabilization element 22 is a bandpass filter with a half-width of 2 nm. A spectrum of the pump beam 20 has a half-width of 2 nm.

The pump beam 20 spreads out in a propagation direction 24 and passes through the laser-active solid body 12.

The laser-active solid body 12 is designed to amplify and/or generate a laser beam not shown in FIG. 1. The laser-active solid body 12 has a crystal structure. The laser-active solid body 12 is made of Nd:YAG. The wavelength of the pump beam 20 is coordinated to the material of the laser-active solid body 12 such that the laser-active solid body 12 is optically pumped with the pump beam 20. For the purpose of optical pumping, the pump beam 20 passes through the laser-active solid body 12. Through optical pumping, the pump beam 20 is partially absorbed by the laser-active solid body 12 as a result of a population inversion. A remaining portion of the pump beam 20 leaves the laser-active solid body 12 as a transmitted pump beam 20.

The laser-active solid body 12 is in the form of a slab.

The optical arrangement 10 has a cooling device 26 for cooling the laser-active solid body 12. The cooling device 26 is designed as a water cooling device. The cooling device 26 has a first cooling plate 28 and a second cooling plate 30. The first cooling plate 28 is arranged on a first longitudinal side of the laser-active solid body 12 and the second cooling plate 30 is arranged on a second longitudinal side opposite the first longitudinal side. The cooling device 26 dissipates heat generated in the laser-active solid body 12 during the amplification and/or generation of the laser beam.

FIG. 2 schematically shows the laser-active solid body 12 in a view along the first longitudinal side of the laser-active solid body 12 without the first cooling plate 30. The laser-active solid body 12 has a first end face 42 and a second end face 44 opposite the first end face 42. The pump beam 20 hits the first end face 42 and is coupled into the laser-active solid body 12 at the end face. The pump beam 20 passes through the laser-active solid body 12 from the first end face 42 to the second end face 44. After passing through the laser-active solid body 12, the pump beam 20 emerges from the laser-active solid body 12 at the second end face 44 in the form of the transmitted pump beam 20.

FIG. 2 shows the laser beam 46. The laser beam 46 spreads out in a propagation direction 48. The laser beam 46 hits the first end face 42 and is coupled into the laser-active solid body 12 at the end face. The laser beam 46 passes through the laser-active solid body 12 from the first end face 42 to the second end face 44. After passing through the laser-active solid body 12, the laser beam 46 emerges from the laser-active solid body 12 at the second end face 44.

The propagation direction 48 of the laser beam 46 and the propagation direction 24 of the pump beam 20 differ from each other. An angle 50 between the propagation direction 48 of the laser beam 46 and the propagation direction 24 of the pump beam 20 is less than 45°. In the illustrated exemplary embodiment shown in FIGS. 1 to 3, the angle 50 is 15°.

The laser beam 46 and the pump beam 20 overlap within the laser-active solid body 12 for the purpose of amplifying the laser beam 46. The amplification of the laser beam 46 is achieved by means of stimulated emission during the propagation of the laser beam 46 and the pump beam 20 through the laser-active solid body 12.

FIG. 1 shows that the reflector 16 is arranged in the propagation direction 24 of the pump beam 20 downstream of the laser-active solid body 12. The reflector 16 is a plane mirror. The reflector 16 has a highly reflective dielectric coating for the pump beam 20. The reflector 16 is a wavelength-selective optical element which is configured to reflect the wavelength of the pump beam 20 more strongly than a wavelength of the laser beam. The reflectivity of the reflector 16 for the wavelength of the pump beam 20 is 99.9%. The reflectivity of reflector 16 for the wavelength of the laser beam is 1%.

The reflector 16 is arranged such that the pump beam 20 transmitted through the laser-active solid body 12 is reflected back onto the laser-active solid body 12. The pump beam 20 reflected by the reflector 16 passes through the laser-active solid body 12 for the purpose of optical pumping. This allows the pump beam 20 to pass bidirectionally through the laser-active solid body 12. The reflector 16 is configured to reflect the transmitted pump beam 20 in such a way that the pump beam 20 is partially superimposed on itself within the laser-active solid body 12 before reflection by the reflector 16 and after reflection by the reflector 16.

For the sake of clarity, the reflected pump beam 20 is not shown in FIG. 2. The pump beam 20 reflected by the reflector 16 hits the second end face 44 and is coupled into the laser-active solid body 12 at the end face. The reflected pump beam 20 passes through the laser-active solid body 12 from the second end face 44 to the first end face 42. After passing through the laser-active solid body 12, a remaining portion of the reflected pump beam 20 exits the laser-active solid body 12 at the first end face 42.

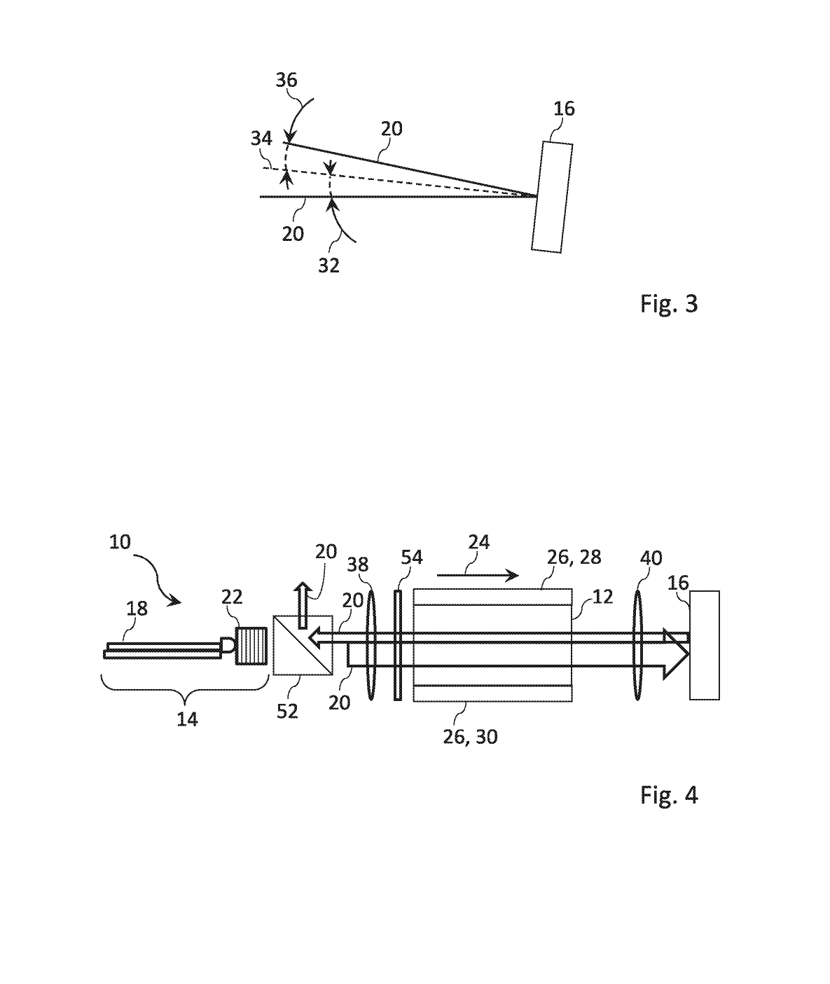

FIG. 3 shows the reflector 16. The reflector 16 is tilted relative to the transmitted pump beam 20. In other words, the reflector 16 is configured such that a value of an angle of incidence 32 of the pump beam 20 transmitted through the laser-active solid body 12 is not equal to 0° relative to the reflector 16. In the example shown in FIGS. 1 and 2, the angle of incidence 32 is 6°. The angle of incidence 32 is limited by the transmitted pump beam 20 and a perpendicular 34 on the reflector 16. Additionally, the reflector 16 is configured such that a value of the emergent angle 36 of the pump beam 20 reflected by the reflector 16 is not equal to 0° relative to the reflector 16. The value of the angle of incidence 32 and the value of the emergent angle 36 are the same. The emergent angle 36 is limited by the reflected pump beam 20 and the perpendicular 34 on the reflector 16.

Due to the tilted reflector 16, the angle between the propagation direction 24 of the pump beam 20 and a propagation direction of the reflected pump beam 20 is 12°.

Because the angle of incidence 32 and the emergent angle 36 are not equal to 0°, the reflected pump beam 20 hits the pump radiation source 14 with less than 3% of its power. The reflected pump beam 20 is guided past the pump radiation source 14 with the remaining 97% of its power. This prevents excessive heating of the pump radiation source as a result of absorption of the reflected pump beam 20 and/or a change in the wavelength of the pump beam 20 as a result of coupling the reflected pump beam 20 into the pump radiation source 14.

The optical arrangement 10 can have a first lens 38 and a second lens 40.

The first lens 38 is arranged between the pump radiation source 14 and the laser-active solid body 12. The first lens 38 is configured to focus the pump beam 20 into the laser-active solid body 12. A focus of the pump beam 20 formed by means of the first lens 38 is located within the laser-active solid body 12.

The second lens 40 is arranged between the laser-active solid body 12 and the reflector 16. The second lens 40 is configured to collimate or image the transmitted pump beam 20. The pump beam 20 strikes the reflector 16 in a collimated or imaged state.

Alternatively or additionally, the second lens 40 can be integrated into the reflector 16 and/or formed on the reflector 16. For example, the reflector 16 itself can be curved for this purpose.

The reflector 16 can, in principle, be integrated into the laser-active solid body 12 or arranged or formed on the laser-active solid body 12. It is therefore not necessarily designed as a separate component.

FIG. 4 shows a further exemplary embodiment of an optical arrangement, wherein, in the exemplary embodiment of FIGS. 1 to 3 and in the exemplary embodiment of FIG. 4, identical and functionally equivalent elements are designated by the same reference numerals, and in this respect reference can be made to the above description of the exemplary embodiment of FIGS. 1 to 3, such that substantially only the existing differences in the exemplary embodiment of FIG. 4 are discussed.

The reflector 16 is arranged straight relative to the transmitted pump beam 20. In other words, the reflector 16 is configured such that the value of the angle of incidence of the pump beam 20 transmitted through the laser-active solid body 12 is 0° relative to the reflector 16. The reflector 16 is configured such that the value of the emergent angle of the pump beam 20 reflected by the reflector 16 is 0° relative to the reflector 16.

Due to the straight arrangement of the reflector 16, the angle between the propagation direction 24 of the pump beam 20 and the propagation direction of the reflected pump beam 20 is 0°. In other words, the propagation direction 24 of the pump beam 20 and the propagation direction of the reflected pump beam 20 are parallel to each other. The propagation direction 24 of the pump beam 20 and the propagation direction of the reflected pump beam 20 are opposite to each other.

The pump beam 20 generated by the pump radiation source 14 is linearly polarized. The degree of polarization of the linearly polarized pump beam 20 is 98%.

The optical arrangement 10 has a polarizer 52. The polarizer 52 is a thin-film polarizer. The polarizer 52 is arranged between the pump radiation source 14 and the laser-active solid body 12. In the exemplary embodiment shown in FIG. 4, the polarizer 52 is arranged between the pump radiation source 14 and the first lens 38. The polarizer 52 is configured to filter the pump beam 20 depending on its polarization such that the pump beam 20 is linearly polarized after the polarizer 52. The polarizer 52 is designed to deflect the pump beam 20 depending on its polarization.

The polarizer 52 is arranged such that the linearly polarized pump beam 20 generated by the pump radiation source 14 passes through the polarizer 52 without power loss.

The optical arrangement 10 has a λ/4 plate 54. The λ/4 plate 54 has a fast axis and a slow axis, wherein the λ/4 plate 54 delays a beam component of the pump beam 20 that is polarized parallel to the slow axis by a quarter wavelength compared to a beam component of the pump beam 20 polarized parallel to the fast axis. λ denotes the wavelength of the pump beam 20.

The λ/4 plate 54 is arranged between the polarizer 52 and the reflector 16. The λ/4 plate 54 is arranged such that the pump beam 20 passes through the λ/4 plate 54 before being reflected by the reflector 16 and the pump beam 20 passes through the λ/4 plate 54 after being reflected by the reflector 16.

In the exemplary embodiment shown in FIG. 4, the λ/4 plate 54 is arranged between the first lens 38 and the laser-active solid body 12. The λ/4 plate 54 is arranged such that the linear polarization of the pump beam 20 is converted into a circular polarization after passing through the λ/4 plate 54. After passing through the λ/4 plate 54, the circularly polarized pump beam 20 passes through the laser-active solid body 12 and is reflected by the reflector 16. The reflected pump beam 20 then passes through the laser-active solid body 12 and the λ/4 plate 54. The λ/4 plate 54 is arranged such that the circular polarization of the pump beam 20 reflected by the reflector 16 is converted into a linear polarization after passing through the λ/4 plate 54. The polarization of the pump beam 20 reflected by the reflector 16 is rotated by 90° after passing through the λ/4 plate 54 compared to the polarization of the pump beam 20 before passing through the λ/4 plate 54. In other words, the λ/4 plate 54 is configured to change the polarization of the pump beam 20 such that the linear polarization of the pump beam 20 before passing through the λ/4 plate 54 and the linear polarization of the pump beam 20 reflected by the reflector 16 after passing through the λ/4 plate 54 are orthogonal to each other.

The pump beam 20 reflected by the reflector 16 hits the polarizer 52 after passing through the λ/4 plate 54. The polarizer 52 is configured to filter the pump beam 20 reflected by the reflector 16 depending on its polarization such that the pump beam 20 reflected by the reflector 16 hits the pump radiation source 14 with less than 2% of its power.

In a further exemplary embodiment of an optical arrangement (not shown), the optical arrangement lacks the second lens. Instead of the second lens, the reflector of the optical arrangement (not shown) has a curved surface. The reflector is configured such that a curvature of the curved surface is equal to a curvature of a phase front of the transmitted pump beam.

In a further exemplary embodiment of an optical arrangement (not shown), the reflector is a retroreflector and is configured to reflect back the pump beam transmitted through the laser-active solid body with a spatial offset. The spatial offset is configured such that the pump beam reflected by the reflector hits the pump radiation source with less than 5%, in particular 3% or 2%, of its power.

As described above, embodiments of the invention provide an optical arrangement which enables the amplification and/or generation of a laser beam with high efficiency.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. An optical arrangement, comprising:
a laser-active solid body configured to amplify and/or generate a laser beam, wherein the laser-active solid body is in a form of a slab,
a pump radiation source configured to generate a pump beam that propagates in a propagation direction and passes through the laser-active solid body for optical pumping the laser-active solid body, and
a reflector arranged downstream of the laser-active solid body in the propagation direction of the pump beam, the reflector being configured to reflect the pump beam transmitted through the laser-active solid body back onto the laser-active solid body, wherein the pump beam reflected by the reflector passes through the laser-active solid body for optical pumping the laser-active solid body.

2. The optical arrangement according to claim 1,
wherein the reflector is configured to reflect back the pump beam transmitted through the laser-active solid body with a spatial offset and/or an angular offset, and
wherein the spatial offset and/or the angular offset is configured such that the pump beam reflected by the reflector hits the pump radiation source with less than 5% of a power thereof.

3. The optical arrangement according to claim 1,
wherein the reflector is configured such that a value of an angle of incidence of the pump beam transmitted through the laser-active solid body is not equal to 0° relative to the reflector, and/or
wherein the reflector is configured such that a value of an emergent angle of the pump beam reflected by the reflector is not equal to 0° relative to the reflector.

4. The optical arrangement according to claim 1,
further comprising a polarizer and a quarter-wave plate,
wherein the polarizer is arranged between the pump radiation source and the laser-active solid body,
wherein the polarizer is configured to filter the pump beam as a function of polarization such that the pump beam has a linear polarization after the polarizer,
wherein the quarter-wave plate is arranged between the polarizer and the reflector, and
wherein the quarter-wave plate is configured to convert the linear polarization of the pump beam into a circular polarization of the pump beam, and to convert the circular polarization of the pump beam into a second linear polarization of the pump beam.

5. The optical arrangement according to claim 4,
wherein the quarter-wave plate is arranged such that the pump beam passes through the quarter-wave plate before being reflected by the reflector and the pump beam passes through the quarter-wave plate after being reflected by the reflector.

6. The optical arrangement according to claim 4,
wherein the quarter-wave plate is configured to change a polarization of the pump beam such that the linear polarization of the pump beam before passing through the quarter-wave plate and the second linear polarization of the pump beam reflected by the reflector after passing through the quarter-wave plate are orthogonal to each other.

7. The optical arrangement according to claim 4,
wherein the polarizer is configured to filter the pump beam reflected by the reflector such that the pump beam reflected by the reflector hits the pump radiation source with less than 5% of a power thereof.

8. The optical arrangement according to claim 1,
wherein the reflector comprises a wavelength-selective element configured to reflect at a wavelength of the pump beam more strongly than at a wavelength of the laser beam.

9. The optical arrangement according to claim 1,
wherein the laser-active solid body is formed from a material that includes Yb:YAG, Nd:YAG, Yb:LuAG, Yb:CaF₂, Yb:CALGO, Yb:CALYO, Yb:GdCOB, Yb:Lu₂O₃, Yb:Sc₂O₃, Yb:S-FAP, Yb:GGG, Nd:YVO₄, Nd:GdVO₄, Yb:KGW, Yb:KYW, Yb:YLF, or Yb:YALO.

10. The optical arrangement according to claim 1,
further comprising a cooling device for cooling the laser-active solid body.

11. The optical arrangement according claim 1,
wherein the reflector has a curved surface, and
wherein the reflector is configured such that a curvature of the curved surface is equal to a curvature of a phase front of the pump beam.

12. The optical arrangement according to claim 1,
wherein the laser beam passes through the laser-active solid body, and
wherein a propagation direction of the laser beam and the propagation direction of the pump beam have an angle of less than 45° relative to each other in the laser-active solid body.

13. The optical arrangement according to claim 1,
wherein the pump radiation source comprises a stabilization element for wavelength stabilization of the pump beam.
